(19) United States
(12) Patent Application Publication
(10) Pub. No.: US 2016/0019531 A1
(43) Pub. Date: Jan. 21, 2016

(54) A METHOD OF PROCESSING A CARD PRESENT, CARD PAYMENT TRANSACTION

(71) Applicants: Dave GORMLEY, (US); MOBIPAYPOINT LIMITED, Dooradoyle, Limerick (IE)

(72) Inventor: Dave Gormley, Newry Down (GB)

(21) Appl. No.: 14/379,195

(22) PCT Filed: Feb. 18, 2013
(86) PCT No.: PCT/EP2013/053217

§ 371 Date: Aug. 15, 2014

(30) Foreign Application Priority Data
Feb. 16, 2012 (EP) 12155850.6
Sep. 28, 2012 (EP) 12186682.6

(51) Int. Cl. G06Q 20/34; G06Q 20/40

(52) U.S. Cl. CPC G06Q 20/341; G06Q 20/4012; G06Q 20/4093; G06Q 20/407

(57) ABSTRACT

This invention relates to a method of processing a card present, card payment transaction. The method (1) comprises obtaining (11, 21) and comparing a PAN taken from the magnetic strip of a card with the PAN taken from the chip of a card. If the PANs are found to differ, the card payment transaction is declined (51) as this is indicative of a fraudulent payment attempt. According to one implementation, if the card payment terminal is unable to retrieve the PAN from either source, the payment transaction is declined (51). In this way, a far more secure method of processing the transaction is provided. According to another implementation, the terminal (103) carries out EMV1 PIN verification before allowing a payment transaction to proceed. In that implementation, additional chip (169) interaction or communication steps subsequent to PIN verification (EMV2 steps) are not required. Therefore, the invention can be performed using existing infrastructure. Furthermore, the security and flexibility of the card payment method are improved.

### TECHNICAL FIELD

This invention relates to a method of processing a card present, card payment transaction.

### BACKGROUND ART

Over the last number of years there has been a consumer trend towards cashless transactions. Use of credit cards and debit cards is on the rise and these methods are seen by many as a more desirable mode of payment than cash. Card payment terminals are commonly used to process credit card payments and debit card payment transactions. In order to process a card payment transaction, the card payment terminal receives payment transaction information including the payment amount and information to identify the account that is to be charged before contacting a remote card network to process the card payment request. The card payment terminals are in some cases used to verify the card ownership of the card holder using so called “Chip and PIN” technology. Although increasing in popularity, there are problems with the known methods of executing credit card and debit card transactions, hereinafter referred to simply as card present, card payment transactions. Most importantly, many of the known card present, card payment transactions are highly susceptible to fraud and many of the transaction methodologies are inherently insecure.

There are several fraudulent attacks that can be made to exploit the weaknesses of card present, card payment transactions. For example, certain card present, card payment transactions rely on reading the magnetic strip data from a card and using that data to process a payment. However, it is relatively simple for criminals with temporary access to the card to “skim” the account details from the magnetic strip and thereafter produce a duplicate card with the same magnetic strip. The duplicate card can thereafter be used to make card present, card payment transactions unbeknownst to the card owner.

In order to enhance the security of card present, card payment transactions, Chip and PIN technology was introduced some years ago. Chip and PIN technology requires the person presenting the card for payment to supply a PIN code that is verified by the Chip on the card. The card payment terminal is used in conjunction with the Chip to verify whether a PIN entered by a card holder into the card payment terminal is the same as the PIN stored on the card's chip. These PIN verification steps are often referred to in the art as EMV1 steps where the PIN is verified locally by the card payment terminal. If the PINs do not correspond with each other, the card payment transaction does not continue further and is terminated. If the PINs do correspond with each other, a communications channel is opened up, facilitated by the card payment terminal, between the Chip on the card and a banking facility charged with the task of processing the payment request. The process steps of communication between the Chip and the banking institution to process a payment are commonly referred to in the art as EMV2 steps.

There are however problems with and barriers to using Chip and Pin technology for the purposes of processing a card payment. First of all, in order to be able to process EMV2 steps, the card issuing bank must provide technical facilities to communicate with and process a payment initiated from a customer-issued Chip and Pin card and a special merchant account must be set up for the merchant in the banking institution. The requirements for setting up such a merchant account are often onerous and difficult for the merchant to satisfy thereby limiting the opportunities for accepting Chip and Pin card payments. Furthermore, the EMV2 steps lock out any other communication or processing options outside of the card issuing bank and their partners thereby restricting the use of the cards to those jurisdictions where the card issuing bank or their partners have a presence or agreements in place to process their cards. In addition to the above, EMV2 steps dictate how the terminal interacts with the chip on the card as well as the communication options it must make available. This means that the terminals do not tend to be transportable from one jurisdiction to another.

In addition to the above, there are also several attacks that may be used against Chip and PIN technology. For example, one technique that is often used with stolen cards is to coat the Chip with clear nail varnish or other coating so that the Chip cannot be read. In these instances, the vendor will typically assume that there is a fault with the machine or an innocent fault with the card and the PIN requirement will be overridden by the terminal operator. The payment will then be processed on the basis of the magnetic strip details which may be fraudulent or which may be from a stolen card.

In more recent times, near field communications (NFC) transactions are gaining in popularity as a way of making very fast card present, card payment transactions. These NFC transactions require an individual to present their card to a NFC reader and the card details are read by the NFC reader and used to process a payment. Although this provides a very fast payment transaction, there are numerous security concerns about this payment methodology. In particular, no other interaction is required other than the card holder bringing their card into close proximity with a card reader in order for the transaction to be completed. It is envisaged that an unscrupulous criminal could use a portable card reader equipped with NFC technology to process payments of third parties' cards, unbeknownst to the card holder, by moving the portable card reader into close proximity to the card. The card could even be stored in a wallet, pocket or a bag at the time. Provided that the mobile card reader is brought into close enough proximity to the card, a payment transaction could be processed without the knowledge or consent of the card holder. Accordingly, at present there is a limitation on the maximum transaction amount that can be processed by these NFC transactions however this is only limiting the exposure to the fraud rather than preventing the fraud occurring in the first place.

It is an object of the present invention to provide a method that overcomes at least some of the above problems with the known methods of processing a card present, card payment transaction. These problems, although they ultimately result in a fraud being perpetrated, are in fact inherently technical in nature as they stem from the insecure methods of processing data in card present, card payment transactions.

### SUMMARY OF INVENTION

According to the invention there is provided a method of processing a card present, card payment transaction using a card payment terminal comprising the steps of:
swiping the card in a magnetic strip reader and retrieving the personal account number (PAN) from a magnetic strip on the card;
retrieving the PAN from a chip on the card;
comparing the PAN retrieved from the chip with the PAN retrieved from the magnetic strip; and
on the PAN from the chip differing from the PAN from the magnetic strip, declining the card present, card payment transaction.

The method according to the invention is significantly more secure than the previously known methods of processing card present, card payment transactions and obviates the possibility of numerous disparate fraudulent attempts. If the PAN on the magnetic strip has been altered or if a duplicate card with a magnetic strip having another card's PAN details loaded thereon is presented, these attempts will be detected and the transaction will be declined. The technical problem of overcoming weaknesses in the known payment processing methodologies is overcome by the technical solution of using the card payment terminal to compare a PAN from two separate, disparate sources on the card. The use of the PAN from both the chip and the magnetic strip is counterintuitive as it lengthens a payment transaction in some instances and is directly contrary to the accepted practice in the field. The technical solution is also provided without having to alter the vast majority of the existing card payment terminals and in most cases can be implemented by using the existing infrastructure in a different way.

In one embodiment of the invention there is provided a method in which the step of retrieving the PAN from the chip on the card comprises using near field communications to retrieve the PAN from the chip on the card. This is seen as a particularly preferred aspect of the present invention and in fact the present invention is particularly suited to overcoming security weaknesses in near field communication (NFC) payment processes. By requiring the card owner to swipe the card, it will not be possible for an unscrupulous individual to process a payment unbeknownst to the card holder. The card holder will have to swipe the card in order for a payment to be processed. This overcomes many of the limitations of NFC payments without increasing significantly the amount of time required to process the payment.

In one embodiment of the invention there is provided a method in which the step of retrieving the PAN from the chip on the card comprises inserting the card into a card reader and using a chip reader to read the chip.

In one embodiment of the invention there is provided a method in which on the card payment terminal being unable to retrieve the PAN from the magnetic strip, the method comprising the step of declining the card present, card payment transaction.

In one embodiment of the invention there is provided a method in which on the card payment terminal being unable to retrieve the PAN from the chip, the method comprises the step of declining the card present, card payment transaction.

In one embodiment of the invention there is provided a method comprising the additional steps of:
the card owner entering a Personal Identification Number (PIN) into the card payment terminal, the card payment terminal passing the entered PIN to the chip on the card for PIN verification;
the card payment terminal receiving verification from the chip as to whether or not the PIN entered by the card owner corresponds to a PIN stored on the chip; and
on the PIN entered into the card payment terminal by the card owner differing from the PIN stored on the chip, terminating the card payment transaction, and on the PIN entered into the card payment terminal by the card owner corresponding to the PIN stored on the chip, proceeding with the card payment transaction.

By implementing such a method, the method provides the security of Chip and PIN technology by carrying out a PIN comparison on the chip but also is more robust as a check is carried out to ensure that the PAN on the magnetic strip, and the account that will ultimately be charged, has not been altered. This will obviate the possibility of the method according to the invention being susceptible to fraud and will enable the card to thereafter be used in numerous disparate types of transactions.

In one embodiment of the invention there is provided a method in which there is further provided a remote processing server comprising a processor, an accessible memory and a communications module for communications with the remote card payment terminal; the method comprising the additional steps of:
the card payment terminal generating a payment packet including the PAN and a payment amount, and transmitting the payment packet to the processing server over the internet; and
the processing server processing the payment packet and returning a payment packet response to the card payment terminal.

In this way, the payment is processed as an internet based, card not present transaction even though the card is present and has been checked. This will allow the flexibility of a card not present internet transaction with the security of a card present transaction that has been thoroughly checked.

In one embodiment of the invention, the PAN for the payment packet is retrieved from the chip. This is seen as a more secure source of the PAN for generation of the payment packet and further obviates the possibility of fraud. In another embodiment, the PAN for the payment packet is retrieved from the magnetic strip.

In one embodiment of the invention there is provided a method comprising the additional step of entering a CVV number of the card into the card payment terminal and in which the payment processing step of generating a payment packet further comprises including the CVV in the payment packet. By providing the CVV number, the method according to the invention will be even more robust and secure than the known methods.

According to another embodiment of the invention, there is provided a method of executing a secure card payment transaction in a system comprising a card payment terminal and a remote processing server; the card payment terminal comprising a magnetic strip swipe slot and a magnetic strip reader, a chip reading slot and a chip reader, a processor, an accessible memory, a communications module for communications with the remote processing server and a user interface capable of receiving user and operator entered data; the processing server comprising a processor, an accessible memory and a communications module for communications with the remote card payment terminal; the method comprising the preliminary steps of:
swiping a card to be used in the card payment transaction in the magnetic strip swipe slot and retrieving a primary account number (PAN) from the magnetic strip;
entering the card to be used in the card payment transaction in the chip reading slot and retrieving a PAN from the chip;
comparing the PAN retrieved from the magnetic strip with the PAN retrieved from the chip; and
on the PAN retrieved from the magnetic strip differing from the PAN retrieved from the chip, terminating the card payment transaction, and on the PAN retrieved from the magnetic strip corresponding to the PAN retrieved from the chip, proceeding with the following PIN verification steps of the card payment transaction:
   the card owner entering a Personal Identification Number (PIN) into the card payment terminal, the card payment terminal passing the entered PIN to the chip on the card for PIN verification;
   the card payment terminal receiving verification from the chip as to whether or not the PIN entered by the card owner corresponds to a PIN stored on the chip; and
   on the PIN entered into the card payment terminal by the card owner differing from the PIN stored on the chip, terminating the card payment transaction, and on the PIN entered into the card payment terminal by the card owner corresponding to the PIN stored on the chip, proceeding with the subsequent payment processing steps of the card payment transaction of:
      the card payment terminal thereafter handling the card payment transaction as a card-not-present transaction by generating a payment packet including an identifier of the merchant associated with the card payment terminal, the PAN and the payment amount, and transmitting the payment packet to the processing server over the internet; and
      the processing server processing the payment packet and returning a payment packet response to the card payment terminal.

This is seen as a particularly beneficial method as Chip and PIN security can be used to augment what is essentially thereafter a card-not-present, internet-based transaction. There is therefore the advantage of card-present security but with card-not-present processing flexibility. The method according to this embodiment of the present invention does not require additional chip interaction or communication steps to be carried out subsequent to PIN verification and therefore can be performed using the existing Internet payment processing infrastructure and without having to provide standard terminal bank merchant accounts for each terminal owner.

As the method according to the invention effectively processes the transaction as a card-not-present internet-based transaction, it does not enter into so-called EMV2 steps of card payment processing including opening a communication channel between the Chip on the card and the banking institution. Instead, the card payment transaction is handled as a card-not-present transaction where the details from the magnetic strip, the amount to charge and the card payment terminal identifier are used to make the payment packet for transmission over the internet and subsequent processing. This provides a very flexible yet secure method of processing card payment transactions.

This method is seen as a particularly suitable way to process the card payment transaction as the method will not be restricted to following EMV2 procedures and will effectively be processed as a card-not-present internet transaction. By not having to follow EMV2 procedures, it will not be necessary for the card payment terminal to have a standard merchant account and for a communication to be set up between the chip and the bank holding the merchant account. Instead, the payment can be treated as an internet transaction and the card payment terminal operator can have a standard bank account for receiving funds from the transaction. Indeed, the funds may be lodged to not only a standard bank account, they can also be lodged to other types of accounts such as electronic wallets, PayPal® accounts, MoneyBookers® accounts or mobile phone accounts. This is not possible with the current terminals using PIN/EMV2 specifications. This increases the number of merchants able to process card payment transactions.

Furthermore, this provides a method in which the terminal is highly portable and is not restricted to processing payments in a particular jurisdiction.

Due to the fact that the method according to the invention processes the card payment transaction in this manner, one way in which an unscrupulous villain may attempt to circumvent the security of the method would be for the villain to use a card that they know the PIN details of but in which they have changed the details on the magnetic strip. In such a scenario, theoretically the PIN check would be returned as successful however an entirely different account, that represented by the details on the magnetic strip, could be charged for the transaction. By implementing the method according to the invention, the payment transaction will be halted on the PAN of the chip differing from the PAN of the magnetic strip and this type of attack is circumvented. This will obviate the possibility of a criminal presenting a card with a PIN code that is known to them but with alternative account information stored on the magnetic strip. In other words, the PAN on the Chip, which cannot be altered, is compared with the PAN on the magnetic strip and if the two PANs are not the same as expected, the payment will be halted.

In one embodiment of the invention the PAN retrieved from the magnetic strip and the PAN retrieved from the chip are compared by the terminal. The advantage of comparing the PANs on the terminal is that it will be possible to quickly verify the accuracy of the PANs and this will avoid delay in the processing of the card payment transaction. Alternatively, the PAN retrieved from the magnetic strip and the PAN retrieved from the chip are transmitted to the processing server for comparison by the processing server.

In one embodiment of the invention the method comprises the initial step of retrieving a card issuing bank identifier from the magnetic strip and determining from the card issuing bank identifier whether or not there should be a chip on the card and in those cases where it is determined from the card issuing bank identifier that there should be no chip on the card:
checking for the presence of a chip on the card, and on detecting the presence of a chip on the card, terminating the card payment transaction, or on failing to detect the presence of a chip:
   using the PAN from the magnetic strip to generate the payment packet and proceeding with the card payment transaction by skipping the steps of:
   retrieving a PAN from the chip;
   comparing the PAN retrieved from the magnetic strip with the PAN retrieved from the chip; and
   the PIN verification steps.

It is envisaged that certain banking institutions may not use Chip and PIN security in which case the method entails checking the unique card issuing bank code to determine whether or not they have Chip and PIN technology. If they do not, the cards of that bank can be used in any event to make a payment using the card payment terminal. It is envisaged that the card payment terminal may provide additional security measures such as presenting a representation of the card on the terminal including a pictorial representation of the card that may be referred to by the card payment terminal operator or by the payment terminal carrying out a check to see if there is a chip present on the card and if there is, alerting the card payment terminal operator that there is in fact a chip present. This will allow them to ensure that it is indeed a card with no chip from that card issuing bank rather than a card with a magnetic strip that has been loaded with that banks details. Similarly, by retrieving the card issuing bank identifier and checking for the presence of a chip, this will facilitate detection of a card that should have a chip but in which no chip is in fact present on the card which is an indicator that the card is fraudulent.

In one embodiment of the invention the processing server communicates with the card payment terminal using protocols such as one of XML and HTML. Effectively, the communications will be over the internet and the method and system operate on the basis of a thin client server based system.

In one embodiment the payment packet is transmitted from the card payment terminal to the processing server using encrypted secure communication protocols such as one of TLS and SSL.

### BRIEF DESCRIPTION OF THE DRAWINGS

The invention will now be more clearly understood from the following description of some embodiments thereof given by way of example only with reference to the accompanying drawings, in which:—

FIG. 1 is flow diagram of a method according to the invention;

FIG. 2 is a diagrammatic representation of a system in which one method according to the invention may be performed;

FIG. 3 is a perspective view of a card payment terminal for use in the method; and

FIG. 4 is a view of the card payment terminal split along a central vertical plane through the middle of the device showing the internal configuration of the slots and readers.

### DETAILED DESCRIPTION OF THE DRAWINGS

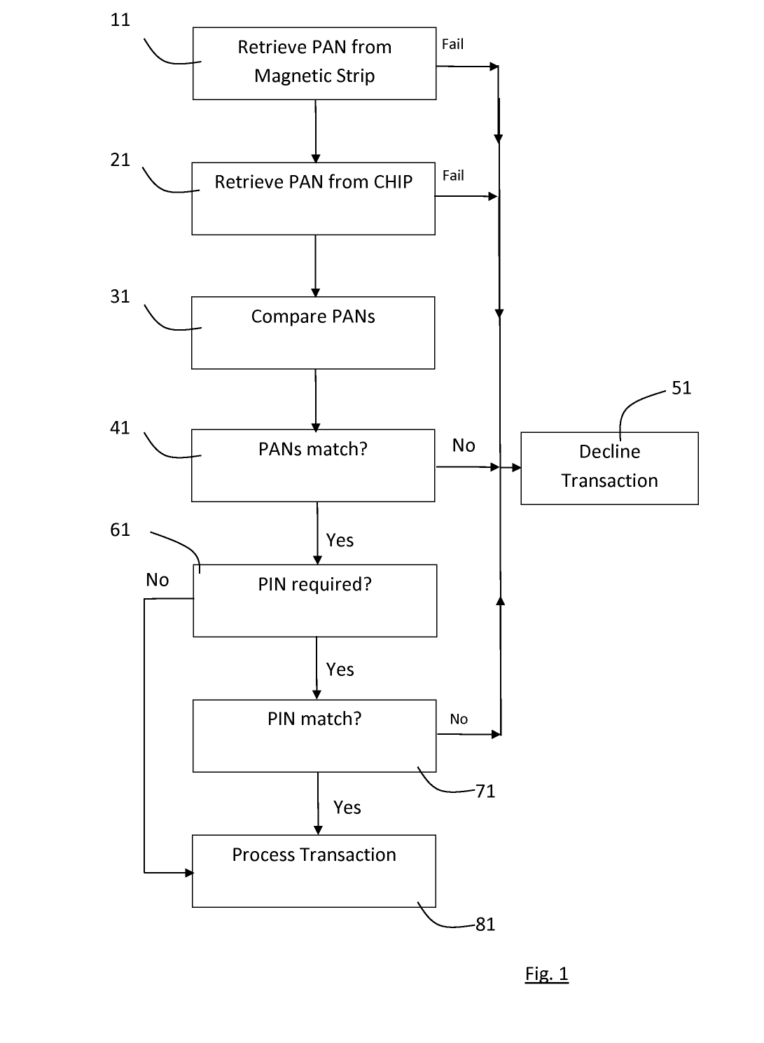

Referring to FIG. 1, there is shown a flow diagram of a first method according to the invention, indicated generally by the reference numeral 1. The method comprises the initial steps of retrieving a personal account number (PAN) from a magnetic strip of a card (step 11) and retrieving the PAN from a chip on the card (step 21). The PAN is retrieved from the chip on the card in step 21 by either inserting the card into a card reader of a card payment terminal or by the card payment terminal using NFC to read the PAN from the chip. The PAN is retrieved from the magnetic strip in step 11 by swiping the card in a magnetic reader of the card payment terminal. The steps 11 and 21 of retrieving the PAN from both the magnetic strip and the chip are not strictly sequential and either step can be performed before or after the other. Indeed, if the card payment terminal is able to do so, the steps 11, 21 can be performed simultaneously.

Once the PANs have been retrieved from the magnetic strip and the chip, the pair of PANs are compared in step 31. If it is determined that the PANs do not match, or in other words, that the PAN on the magnetic strip is not the same as the PAN on the chip in step 41, the card present, card payment transaction is declined in step 51. If however it is determined that the PAN on the magnetic strip is the same as the PAN on the chip in step 41, the method proceeds to step 61 where a check is carried out to see whether a PIN is required. It will be understood that for NFC type transactions, a PIN will not be required however if Chip and PIN authentication is required, the card holder will be requested to enter their PIN. If no PIN is required, the method proceeds to step 81 in which the transaction is processed. If however a PIN is required, the card holder will be prompted to enter their PIN by the card payment terminal and the card will verify whether or not the PIN entered is a match to the PIN on the card's chip in step 71. If the PIN on the card is not a match to the PIN entered, the method proceeds to step 51 and the transaction is declined. Additional PIN entry attempts may be allowed. If however, the PIN on the card is a match to the PIN entered, the method proceeds to step 81 and the transactions is processed.

In addition to the above, according to a first embodiment of the present invention, if the card payment terminal is unable to retrieve either of the PAN from the magnetic strip or the PAN from the chip in steps 11 and 21 respectively, the method proceeds to step 51 and the transaction is declined.

In order to process the transaction, a payment packet is generated by the card payment terminal and the payment packet is transmitted to a remote payment processing server. The payment packet includes the PAN and a payment amount. If desired, the payment packet may also include one or more of a name of the card account owner and an expiry date of the card. The remote processing server comprises a processor, an accessible memory and a communications module for communications with the remote card payment terminal. Preferably, the payment packet is transmitted to the processing server over the internet and processed as an internet based, card not present transaction as this will provide greater flexibility to process the card present, card payment transaction and will allow the process to proceed without being restricted to EMV2 specification steps. The remote payment processing server processes the payment packet and returns a payment packet response, if required, to the card payment terminal. Furthermore, the method may comprise the additional step of a terminal operator or the card holder entering a CVV number of the card into the card payment terminal and the payment processing step of generating a payment packet further comprises including the CVV in the payment packet. Again, this will enhance the security of the method.

In the above embodiment, the transaction is processed online in real time. As an alternative, the transaction may be processed offline. In other words, one or more transaction payment packets may be stored and batched for subsequent processing. Preferably, the PAN from the chip is used in the payment packet. Alternatively, the PAN from the magnetic strip could be used in the payment packet.

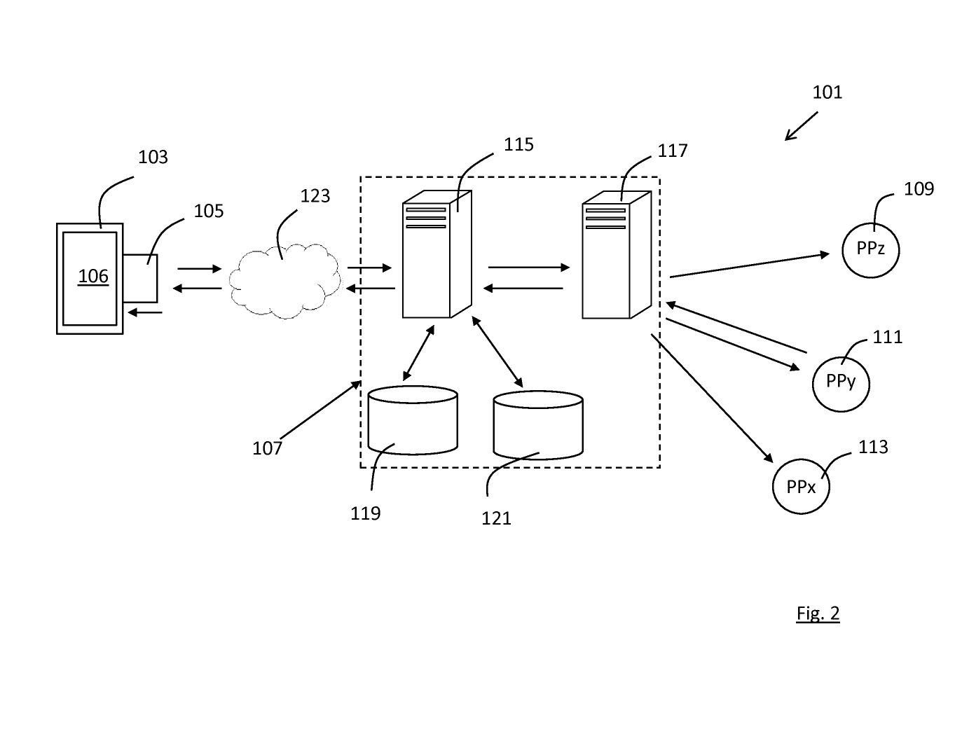

Referring to FIG. 2, there is shown a system, indicated generally by the reference numeral 101, comprising a card payment terminal 103 and a card 105 for use in a card payment transaction according to a second alternative embodiment of the invention. The card payment terminal 103 comprises a chip reader (not shown), a magnetic strip reader (not shown) and a user interface 106. The system comprises a processing server sub-system, indicated generally by the reference numeral 107, the constituent parts of which are bounded by a dashed line, and a plurality of payment processors 109, 111 and 113 each of which is associated with a bank card network (not shown). The processing server sub-system 107 further comprises a processing server 115, a processing server routing server 117 and a pair of databases 119, 121. The database 119 stores information relating to the card payment terminals 103 including the merchant's account details relating to the individual card payment terminals 103. The database 121 stores details relating to the card payment transactions such as the amount, the payment beneficiary and the like processed through the individual card payment terminals 103. The processing server 115 has a communications module (not shown) for communicating with the remote card payment terminal 103.

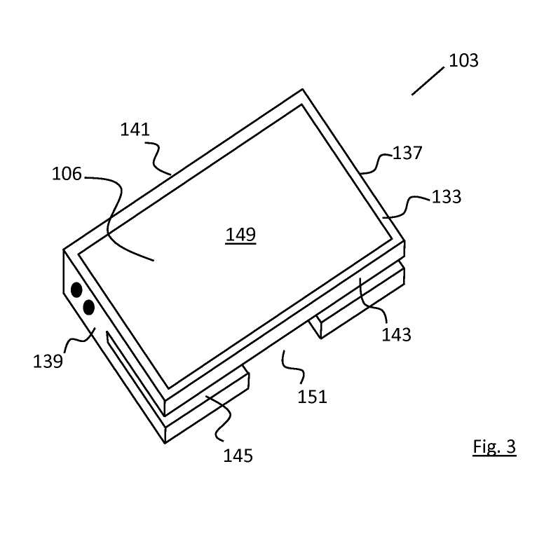

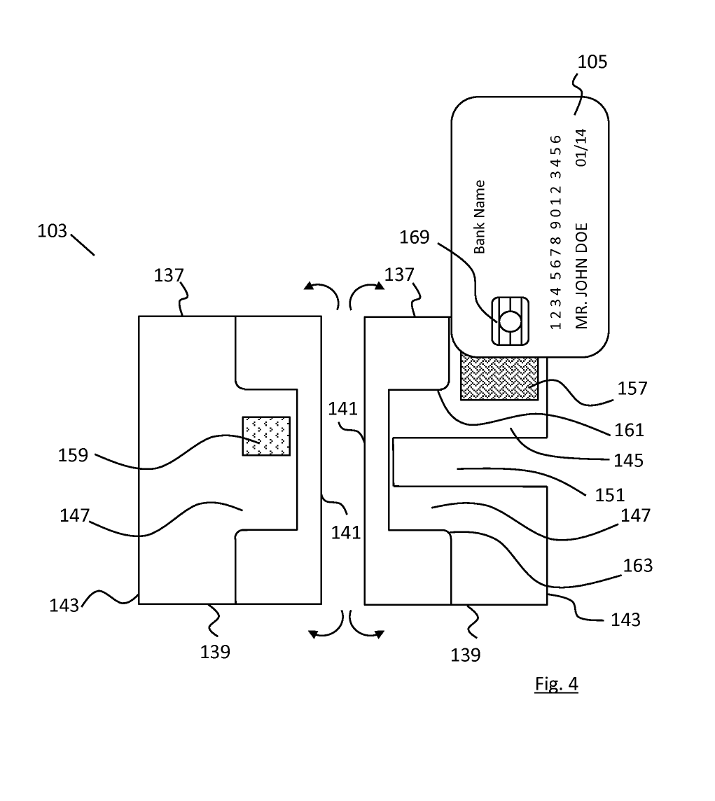

Referring to FIGS. 3 and 4, there is shown a pair of diagrammatic representations of the card payment terminal 103, comprising a casing having a front side 133, a rear side, a top side 137, a bottom side 139, a left side 141 and a right side 143. A magnetic swipe card slot 145 is formed in the casing on the right side of the casing and extends along the entire length of the side from the top 137 to the bottom 139. A chip reading slot 147 (as illustrated in FIG. 4) is also formed in the casing perpendicular to the magnetic strip swipe slot 145. The chip reading slot 147 and the magnetic strip swipe slot 145 are co-planar and share a common slot portion therebetween i.e. that portion of the slots that overlap. The representations of card payment terminal shown are not intended to be limiting but are provided to illustrate many of the features that may be provided on a payment terminal suitable for use with the present invention. other constructions of terminal are readily envisaged.

The payment terminal 103 contains components necessary for completing card payments including a processor, an accessible memory including volatile memory and non-volatile memory and a communications module (not shown) for communication with the remote processing server 115. There is further provided a user interface 106, in this case provided by way of a touchscreen 149 on the front of the payment terminal. The touchscreen 149 is capable of displaying payment information and providing a keypad for the insertion of payment information. The communications module is capable of setting up a connection to the internet and the payment terminal effectively comprises a web browser to display a web page on at least portion of the user interface, thereby allowing the payment transaction to be completed not according to the EMV2 specification but instead as if it were an internet based, card-not-present purchase transaction. The method according to the present invention does not require additional chip interaction or communication steps to be carried out subsequent to PIN verification.

The payment terminal comprises a Card Verification Value (CVV) code viewing aperture 151 formed in the rear of the casing coincident with the chip reading slot 147 to permit viewing of the CVV code from a card when the card is fully inserted in the chip reading slot 147. The CVV code viewing aperture extends practically the entire way across the rear of the casing from the right side to a point adjacent to the left side of the casing.

Referring specifically to FIG. 4, there is shown a view of the card payment terminal split along a central vertical plane through the middle of the device showing the internal configuration of the slots 145, 147 in more detail and a pair of readers, namely a magnetic strip reader 157 and a chip reader 159, located internal the payment terminal adjacent to their respective slot. The magnetic strip reader 157 is located in the payment terminal adjacent the top side 137 of the payment terminal. In this position, the magnetic strip reader 157 will be able to read data from a magnetic strip on a card 105 passed through the magnetic strip swipe slot. The magnetic strip reader is positioned to the side of the magnetic strip swipe slot adjacent the rear of the casing. The chip reader 159 is located adjacent the inner end of the chip reading slot 147 and is positioned to the side of the chip reading slot 147 adjacent the front 133 of the casing. In this position, the chip reader 159 will be able to read data from a chip 169 on the card 105 when the card 105 is fully inserted into the chip reader slot 147 and facing forwards in the slot. The above configuration of card payment terminal will be particularly suitable for use in the method according to the invention. Again, alternative constructions of card payment terminal are readily envisaged.

In use, in order to make a card payment transaction, a card holder will pass their card to the operator of the card payment terminal 103. The operator of the card payment terminal 103 will swipe the card 103 in the magnetic strip swipe slot 145 and the Primary Account Number (PAN) including other card details such as the card account holder name and the expiry date of the card will be read from the magnetic strip. Then, the operator of the card payment terminal 103 will insert the card 105 in the chip reading slot 147 and the chip reader 159 will read the PAN from the chip 169. The card payment terminal 103 will then compare the PAN from the magnetic strip with the PAN from the chip 169. If the PAN from the strip is the same as the PAN from the chip, the card payment transaction is allowed to proceed however if the PAN from the strip is different to the PAN from the chip, the card payment transaction is terminated. As an alternative to the payment terminal comparing the PAN from the magnetic strip with the PAN from the chip, the comparison could be carried out on either the processing server or a dedicated processor chip on the terminal itself.

The method further comprises the steps of a card holder entering a PIN into the card payment terminal and the payment terminal submitting the PIN to the chip on the card for comparison with the PIN stored on the card's chip. If the PIN entered into the payment terminal and the PIN on the chip are not identical, the terminal may terminate the card payment request. Once the PAN and the PIN have been verified, the card payment transaction will proceed. In a preferred embodiment, this will entail the operator of the device (or indeed a customer making a payment) entering the CVV code that appears on the rear of the card into the terminal and the terminal then packaging the CVV code with the verified PAN from either the Chip or magnetic strip, along with the amount to be charged and (optionally) the card account owner name, the expiry date of the card, the card payment terminal identifier together into a payment packet and transmitting the payment packet to the processing server 115.

The payment packet is preferably built in parts or in whole by the payment terminal in response to requests passed to it by the processing server and the processing server may require more or less information than that outlined above. For example, the processing server may obtain the location of the terminal and the card being charged. For magnetic strip only cards, the processing server may store the signature given by the user on the touch screen, however the signature itself may or may not be used in the actual payment processing.

The processing server 115 thereafter saves various components of the payment packet in databases 119, 121 and passes the payment packet to the processing server routing server 117 which will select the most appropriate payment processor 109, 111, 113 to send the payment request to. The payment processors are each connected to a card payment network (not shown). The processing server routing server 117 will also modify the payment packet into a format suitable for that payment processor and the card payment network associated therewith if necessary.

It can be seen from the foregoing that due to the fact that the CVV, the PAN and the other card details contained in the payment request are commonly entered by a card holder making an Internet/Web based purchase, the payment request can be treated as an internet, card-not-present transaction. By “treated as an internet card-not-present transaction”, what is meant is that the transaction is treated in a similar manner to an internet card not present transaction (i.e. as if the card had not physically been presented to the merchant). It will be understood that the purchaser but not the merchant has the card for those internet card-not-present transactions. In the present invention, the transaction is handled by the merchant to an extent as if it were an internet card-not-present transaction although the card will in fact have been presented to the merchant for swiping or PIN entry. Advantageously, the transaction is charged as a card present transaction rather than a card-not-present transaction. Typically, card present transactions incur a lower transaction processing fee than card-not-present transaction and the method according to the invention can avail of these lower rates. However, it can be seen that the method according to the invention advantageously obtains card-present verification through PIN verification prior to transmitting the payment packet. Therefore, the method according to the present invention has the security of a card-present transaction verified to a very high standard but with the flexibility consistent with that of an internet based transaction. The payment request can be passed into any number of payment processors 109, 111, 113 that will process the payment. It is clear from the foregoing description of the invention that standard merchant accounts are not necessary for the implementation of the present invention however if desired the present invention can still be used in conjunction with a dedicated merchant account and is not limited to use with standard accounts.

In the embodiments described, the processing server communicates with the card payment terminal using protocols such as one of XML and HTML. Preferably, the payment packet is transmitted from the card payment terminal to the processing server using encrypted secure communication protocols such as one of TLS and SSL.

It will be understood that the method according to the present invention will be performed largely in software and therefore the present invention extends also to computer programs, on or in a carrier, comprising program instructions for causing a computer or a payment terminal to carry out steps of the method. In particular, the PAN comparison steps and the PIN provision steps may be carried out largely in software. The computer program may be in source code format, object code format or a format intermediate source code and object code. The computer program may be stored on or in a carrier, in other words a computer program product, including any computer readable medium, including but not limited to a floppy disc, a CD, a DVD, a memory stick, a tape, a RAM, a ROM, a PROM, an EPROM or a hardware circuit. In certain circumstances, a transmissible carrier such as a carrier signal when transmitted either wirelessly and/or through wire and/or cable could carry the computer program in which cases the wire and/or cable constitute the carrier. The computer program product may be stored in the memory of a card payment terminal and the present invention is intended to extend to card payment terminals programmed to implement the method according to the present invention.

It will be further understood that the present invention may be performed on two, three or more machines or components with certain parts of the computer-implemented method being performed by one machine or component and other parts of the computer-implemented method being performed by another machine or component. The devices may be part of a LAN, WLAN or could be connected together over a communications network including but not limited to the internet. One or more of the method steps could be performed “in the cloud”, meaning that remotely located processing power may be utilised to process certain method steps of the present invention. Accordingly, it will be understood that many of the method steps may be performed remotely, by which it is meant that the method steps could be performed either on a separate machine in the same locality or jurisdiction or indeed on a separate machine or machines in one or several remote jurisdictions. For example, the card payment terminal and the processing server may be in one jurisdiction or located in different jurisdictions. Furthermore, the card payment terminal, the processing server and a bank card network may all be in different jurisdictions or one or more parts of the system may be located in one jurisdiction with one or more other parts of the system in another jurisdiction or multiple jurisdictions. The present invention and claims are intended to also cover those instances where the method is performed across two or more machines or pieces of apparatus located in one or more jurisdictions and those situations where the parts of the system are spread out over one or more jurisdictions.

Throughout this specification, the term Card Verification Value (CVV) code has been used however it will be understood that many different terms and acronyms are used to describe the same code, including, but not limited to CVV2, the Card Verification Code (CVC/CVC2), the Card Code Verification (CCV), the Card Security Code (CSC), the Card Verification Data (CVD), the Card Verification Value Code (CVVC) or simply the Verification Code (V-Code). In this specification, the CVV code is a code not stored on the magnetic strip but instead is printed on the card itself. For MasterCard®, Visa® and some other Credit and Debit cards, presently, the CVV is a three digit code printed on the rear of the card on the signature strip. Other card providers, such as American Express®, presently print a four digit CVV code on the front right hand side of the card.

Throughout the specification, reference is made to the EMV1 and EMV2 specifications. It will be understood that these references and requirements relate to the EMV1 and EMV2 specifications and requirements at the date of filing of the application in suit or date of priority if claimed. Finally, reference is made to banking institutions in the specification and this is intended to also cover partners of the banking institutions that provide card payment processing services to the banking institutions.

In this specification the terms “include, includes, included and including” and the terms “comprise, comprises, comprised and comprising” are all deemed totally interchangeable and should be afforded the widest possible interpretation.

The invention is in no way limited to the embodiment hereinbefore described but may be varied in both construction and detail within the scope of the appended claims.

1) A method of processing a card present, card payment transaction using a card payment terminal comprising the steps of:
swiping a card in a magnetic strip reader and retrieving a personal account number (PAN) from a magnetic strip on the card;
retrieving a personal account number PAN from a chip on the card;
comparing the PAN retrieved from the chip with the PAN retrieved from the magnetic strip; and
on the PAN from the chip differing from the PAN from the magnetic strip, declining the card present, card payment transaction.

2) The method as claimed in claim 1 in which the step of retrieving the PAN from the chip on the card comprises using near field communications reader to retrieve the PAN from the chip on the card.

3) The method as claimed in claim 1 in which the step of retrieving the PAN from the chip on the card comprises inserting the card into a card reader and using a chip reader to read the chip.

4) The method as claimed in claim 1 in which on the card payment terminal being unable to retrieve the PAN from the magnetic strip, the method comprising the step of declining the card present, card payment transaction.

5) The method as claimed in claim 1 in which on the card payment terminal being unable to retrieve the PAN from the chip, the method comprising the step of declining the card present, card payment transaction.

6) The method as claimed in claim 1 comprising the additional steps of:
the card owner entering a Personal Identification Number (PIN) into the card payment terminal, the card payment terminal passing the entered PIN to the chip on the card for PIN verification;
the card payment terminal receiving verification from the chip as to whether or not the PIN entered by the card owner corresponds to a PIN stored on the chip; and
on the PIN entered into the card payment terminal by the card owner differing from the PIN stored on the chip, terminating the card payment transaction, and on the PIN entered into the card payment terminal by the card owner corresponding to the PIN stored on the chip, proceeding with the card payment transaction.

7) The method as claimed in claim 1 in which there is further provided a remote processing server comprising a processor, an accessible memory and a communications module for communications with the remote card payment terminal; the method comprising the additional steps of:
the card payment terminal generating a payment packet including the PAN and a payment amount and transmitting the payment packet to the processing server over the internet; and
the processing server processing the payment packet and returning a payment packet response to the card payment terminal.

8) The method as claimed in claim 7 in which the PAN for the payment packet is retrieved from the chip.

9) The method as claimed in claim 7 in which the PAN for the payment packet is retrieved from the magnetic strip.

10) The method as claimed in claim 7 comprising the additional step of entering a CVV number of the card into the card payment terminal and in which the payment processing step of generating a payment packet further comprises including the CVV in the payment packet.

11) The method of executing a secure card payment transaction in a system comprising a card payment terminal and a remote processing server,
the card payment terminal comprising a magnetic strip swipe slot and a magnetic strip reader, a chip reading slot and a chip reader, a processor, an accessible memory, a communications module for communications with the remote processing server and a user interface capable of receiving user and operator entered data;
the processing server comprising a processor, an accessible memory and a communications module for communications with the remote card payment terminal; the method comprising the preliminary steps of:
swiping a card to be used in the card payment transaction in the magnetic strip swipe slot and retrieving a primary account number (PAN) from the magnetic strip;
entering the card to be used in the card payment transaction in the chip reading slot and retrieving a primary account number PAN from the chip;
comparing the PAN retrieved from the magnetic strip with the PAN retrieved from the chip; and
on the PAN retrieved from the magnetic strip differing from the PAN retrieved from the chip, terminating the card payment transaction, and on the PAN retrieved from the magnetic strip corresponding to the PAN retrieved from the chip, proceeding with the following PIN verification steps of the card payment transaction:
the card owner entering a Personal Identification Number (PIN) into the card payment terminal, the card payment terminal passing the entered PIN to the chip on the card for PIN verification;
the card payment terminal receiving verification from the chip as to whether or not the PIN entered by the card owner corresponds to a PIN stored on the chip (169); and
on the PIN entered into the card payment terminal by the card owner differing from the PIN stored on the chip, terminating the card payment transaction, and on the PIN entered into the card payment terminal by the card owner corresponding to the PIN stored on the chip proceeding with the subsequent payment processing steps of the card payment transaction of:
the card payment terminal thereafter handling the card payment transaction as a card-not-present transaction by generating a payment packet including an identifier of the merchant associated with the card payment terminal, the PAN and the payment amount, and transmitting the payment packet to the processing server over the internet; and
the processing server processing the payment packet and returning a payment packet response to the card payment terminal.

12) The method as claimed in claim 11 comprising the additional step of entering a CVV number of the card into the card payment terminal and in which the payment processing step of generating a payment packet further comprises including the CVV in the payment packet.

13) The method as claimed in claim 11 in which the PAN retrieved from the magnetic strip and the PAN retrieved from the chip are compared by the card payment terminal.

14) The method as claimed in claim 11 in which the method comprises the initial step of retrieving a card issuing bank identifier from the magnetic strip and determining from the card issuing bank identifier whether or not there should be a chip on the card and in those cases where it is determined from the card issuing bank identifier that there should be no chip on the card:
checking for the presence of a chip on the card, and on detecting the presence of a chip on the card, terminating the card payment transaction, and, on failing to detect the presence of a chip:
using the PAN from the magnetic strip to generate the payment packet and proceeding with the card payment transaction by skipping the steps of:
retrieving a PAN from the chip;
comparing the PAN retrieved from the magnetic strip with the PAN retrieved from the chip; and
the PIN verification steps.

15) The method as claimed in claim 12 in which the PAN retrieved from the magnetic strip and the PAN retrieved from the chip are compared by the card payment terminal.

16) The method as claimed in claim 12 in which the method comprises the initial step of retrieving a card issuing bank identifier from the magnetic strip and determining from the card issuing bank identifier whether or not there should be a chip on the card and in those cases where it is determined from the card issuing bank identifier that there should be no chip on the card:
checking for the presence of a chip on the card, and on detecting the presence of a chip on the card, terminating the card payment transaction, and, on failing to detect the presence of a chip:
using the PAN from the magnetic strip to generate the payment packet and proceeding with the card payment transaction by skipping the steps of:
retrieving a PAN from the chip;
comparing the PAN retrieved from the magnetic strip with the PAN retrieved from the chip; and
the PIN verification steps.

17) The method as claimed in claim 2 in which on the card payment terminal being unable to retrieve the PAN from the magnetic strip, the method comprising the step of declining the card present, card payment transaction.

18) The method as claimed in claim 2 in which on the card payment terminal being unable to retrieve the PAN from the chip, the method comprising the step of declining the card present, card payment transaction.

19) The method as claimed in claim 2 comprising the additional steps of:
the card owner entering a Personal Identification Number (PIN) into the card payment terminal, the card payment terminal passing the entered PIN to the chip on the card for PIN verification;
the card payment terminal receiving verification from the chip as to whether or not the PIN entered by the card owner corresponds to a PIN stored on the chip; and
on the PIN entered into the card payment terminal by the card owner differing from the PIN stored on the chip, terminating the card payment transaction, and on the PIN entered into the card payment terminal by the card owner corresponding to the PIN stored on the chip, proceeding with the card payment transaction.

20) The method as claimed in claim 2 in which there is further provided a remote processing server comprising a processor, an accessible memory and a communications module for communications with the remote card payment terminal; the method comprising the additional steps of:
the card payment terminal generating a payment packet including the PAN and a payment amount and transmitting the payment packet to the processing server over the internet; and
the processing server processing the payment packet and returning a payment packet response to the card payment terminal
